(19) United States
(12) Patent Application Publication
(10) Pub. No.: US 2008/0201775 A1
(43) Pub. Date: Aug. 21, 2008

(54) Multifunction peripheral, password setting system, method and computer readable medium for password setting

(75) Inventor: Takafumi Kai, Nagoya (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 12/071,322

(22) Filed: Feb. 20, 2008

(30) Foreign Application Priority Data
Feb. 20, 2007 (JP) 2007-039205

(51) Int. Cl. H04L 9/32

(52) U.S. Cl. 726/19

(57) ABSTRACT

There is provided a multifunction peripheral comprising an operation unit, a key definition unit to define usable keys for password setting depending on a type of a certain function, a password setting unit to accept a password through the usable keys defined by the key definition unit and to set the password in the multifunction peripheral, a password authentication unit configured such that when execution of the certain function is instructed, the password authentication unit accepts a password through the plurality of keys of the operation unit and judges whether the password accepted through the plurality of keys matches the password set by the password setting unit, and a function control unit configured to permit execution of the certain function if it is judged by the password authentication unit that the password accepted through the plurality of keys matches the password set by the password setting unit.

### CROSS-REFERENCE TO RELATED APPLICATION

This application claims priority under 35 U.S.C. § 119 from Japanese Patent Application No. 2007-039205, filed on Feb. 20, 2007. The entire subject matter of the application is incorporated herein by reference.

### BACKGROUND

1. Technical Field

Aspects of the present invention relate to a password setting system and a multifunction peripheral used for password setting.

2. Related Art

Multifunction peripherals (MFPs) having a print function, a facsimile function, a copying function and a scanner function have been widely used. For example, such a multifunction peripheral is used in an environment where a single MFP is shared by a plurality of personal computers via a network. In such an environment, a possibility that a confidential document made by printing out confidential data may be exposed to another person arises. A possibility that scanned data made by reading a confidential original may be exposed to another person also arises. Since the MFP is shared by a plurality of users, the setting of the MFP may be modified in contradiction to a certain user, which is very inconvenient for the certain user.

Recent MFPs are provided with a function of password setting and authentication. According to such a configuration of the MFP, it is possible to control the MFP such that when a user who transmitted confidential data to the MFP inputs a password (which has been set in the MFP) to the MFP, the MFP prints the confidential data (i.e., a secured printing operation). It is also possible to control the MFP to transmit scanned data of a confidential document to a particular personal computer. On the MFP, a particular administrator is authorized to change settings of the MFP. That is, in this case, the MFP permits change of settings of the MFP only when a password inputted by the particular administrator is authenticated.

Regarding password setting, the number of combinations of numbers becomes small if a password is set only by a train of numbers. Therefore, in this case, the level of security is relatively low. On the other hand, if the number of usable letters for a password is increased, it becomes hard for a user to keep such a password in mind. In general, the MFP is provided with function keys for setting and executing functions of the MFP in addition to having a ten-key.

Japanese Patent Provisional Publication No. 2005-275943 discloses a multifunction peripheral configured to allow a user to set a password as a combination of a ten-key and function keys and to permit a user to use a function only when an inputted password (which is formed by a ten-key and function keys) matches a registered password (which is also formed by a ten-key and function keys). According to such a configuration, the number of keys to be used for password setting can be reduced while making it possible to form a relatively complicated password. Consequently, it becomes possible to prevent unauthorized use of the MFP from occurring.

However, regarding a user operation for inputting a password, another person easily watches the user operation conducted through an operation unit of the MFP. Therefore, there is a possibility that a password is stolen by another person. That is, the level of security of the above mentioned MFP is relatively low.

### SUMMARY

Aspects of the present invention are advantageous in that at least one of a multifunction peripheral, a password setting system, a method and a computer readable medium for password setting capable of enhancing the level of security is provided.

According to an aspect of the invention, there is provided a multifunction peripheral having a plurality of functions. The multifunction peripheral comprises an operation unit that has a plurality of keys to be operated, a key definition unit configured to define usable keys for password setting depending on a type of a certain function selected from the plurality of functions, the usable keys being chosen from among the plurality of the keys of the operation unit, a password setting unit configured to accept a password through the usable keys defined by the key definition unit and to set the password in the multifunction peripheral, a password authentication unit configured such that when execution of the certain function is instructed, the password authentication unit accepts a password through the plurality of keys of the operation unit and judges whether the password accepted through the plurality of keys matches the password set by the password setting unit, and a function control unit configured to permit execution of the certain function if it is judged by the password authentication unit that the password accepted through the plurality of keys matches the password set by the password setting unit.

The above mention configuration of the multifunction peripheral makes it possible to limit keys to be used for password setting depending on a type of a certain function of the plurality of functions, and thereby to complicate passwords so that the security level can be enhanced.

According to another aspect of the invention, there is provided a password setting system, comprising an information processing device; and a multifunction peripheral having a plurality of functions. In this system, the information processing unit and the multifunction peripheral being communicatably connected with each other. The information processing device comprises: a display control unit configured to display a virtual key operation unit corresponding to an image of an operation unit of the multifunction peripheral; a password setting unit configured to accept an password through the virtual key operation unit and to set the password in the information processing device; and a password transmission unit configured to transmit the password set by the password setting unit to the multifunction peripheral. The multifunction peripheral comprising: the operation unit having a plurality of keys; a password receiving unit configured to receive the password from the information processing device; a password authentication unit configured such that when execution of a certain function is instructed, the password authentication unit accepts a password through the operation unit and judges whether the password accepted through the plurality of keys of the operation unit matches the password received by the password receiving unit; and a function control unit configured to permit execution of the certain function if it is judged by the password authentication unit that the password accepted through the operation unit matches the password received by the password receiving unit.

The above mentioned configuration of the password setting system makes it possible to conduct password entry on the information processing device located at a hidden position. Therefore, it is possible to prevent passwords from being stolen by another person. Consequently, the security level can be increased.

According to another aspect of the invention, there is provided a computer readable medium having computer readable instruction stored thereon, which, when executed by a processor of an information processing device communicatably connected to a multifunction peripheral, configures the processor to perform the steps of: displaying a virtual key operation unit corresponding to an image of an operation unit of the multifunction peripheral; accepting a password through the virtual key operation unit; and transmitting the accepted password to the multifunction peripheral.

Such a configuration makes it possible to conduct password entry on the information processing device located at a hidden position. Therefore, it is possible to prevent passwords from being stolen by another person. Consequently, the security level can be increased.

According to another aspect of the invention, there is provided a method for controlling a multifunction peripheral for executing a certain function selected from a plurality of functions of the multifunction peripheral. The method comprises the steps of: defining usable keys for password setting depending on a type of the certain function selected from the plurality of functions, the usable keys being chosen from among a plurality of keys of an operation unit of the multifunction peripheral; accepting a password through the defined usable keys to set the password in the multifunction peripheral; accepting a password through the plurality of keys of the operation unit to judge whether the password accepted through the plurality of keys matches the password set in the multifunction peripheral when execution of the certain function is instructed; and permitting execution of the certain function if it is judged that the password accepted through the plurality of keys matches the password set in the multifunction peripheral.

The above mention configuration of the method makes it possible to limit keys to be used for password setting depending on a type of a certain function of the plurality of functions of the multifunction peripheral, and thereby to complicate passwords so that the security level can be enhanced.

It is noted that various connections are set forth between elements in the following description. It is noted that these connections in general and unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

### BRIEF DESCRIPTION OF THE ACCOMPANYING DRAWINGS

FIG. 1 is a conceptual block diagram illustrating a password setting system according to a first embodiment.

FIG. 2 illustrates an inner structure of an MFP (Multifunction Peripheral).

FIG. 3 is a plan view of an operation unit of the MFP.

FIG. 4 illustrates a block diagram of a control unit of the MFP.

FIG. 5 is a flowchart illustrating a password input program.

FIG. 6 is a sub-flowchart illustrating a password string input process.

FIG. 7 is a flowchart illustrating a password authentication process corresponding to a password authentication program.

FIG. 8 illustrates a system configuration of a password setting system according to a second embodiment.

FIG. 9 is a flowchart illustrating a password setting process corresponding to a password setting program.

FIG. 10 is a flowchart illustrating a setting process for a secured printing operation.

FIG. 11 illustrates an example of a print setting screen displayed during execution of the password setting process shown in FIG. 9.

FIG. 12 is an example of a password setting screen displayed during the setting process for a secured printing operation shown in FIG. 10.

### DETAILED DESCRIPTION

Hereafter, an embodiment according to the invention will be described with reference to the accompanying drawings.

### First Embodiment

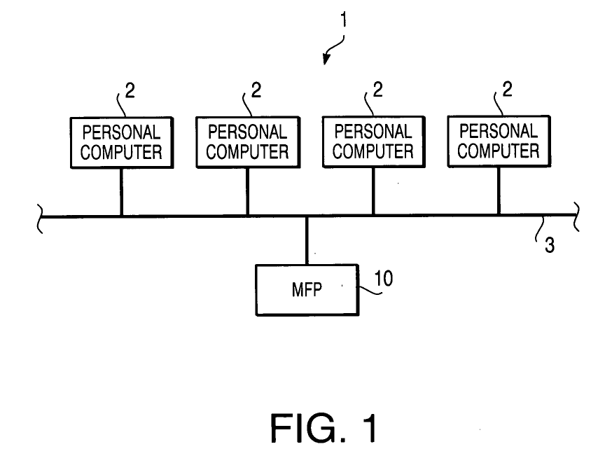

FIG. 1 is a conceptual block diagram illustrating a password setting system 1 according to a first embodiment. As shown in FIG. 1, in the password setting system 1, PCs (Personal Computers) 2 each of which functions as an information processing device are communicatably connected to an MFP (Multifunction Peripheral) 10 via a LAN 3.

The PC 2 is configured to load a printer driver into an inner memory thereof to communicate with the MFP 10 via the printer driver. The MFP 10 has a plurality of functions including a print function, a facsimile function, a copying function, and a scanner function. By operating an operation unit 25, one of the functions can be selected and executed.

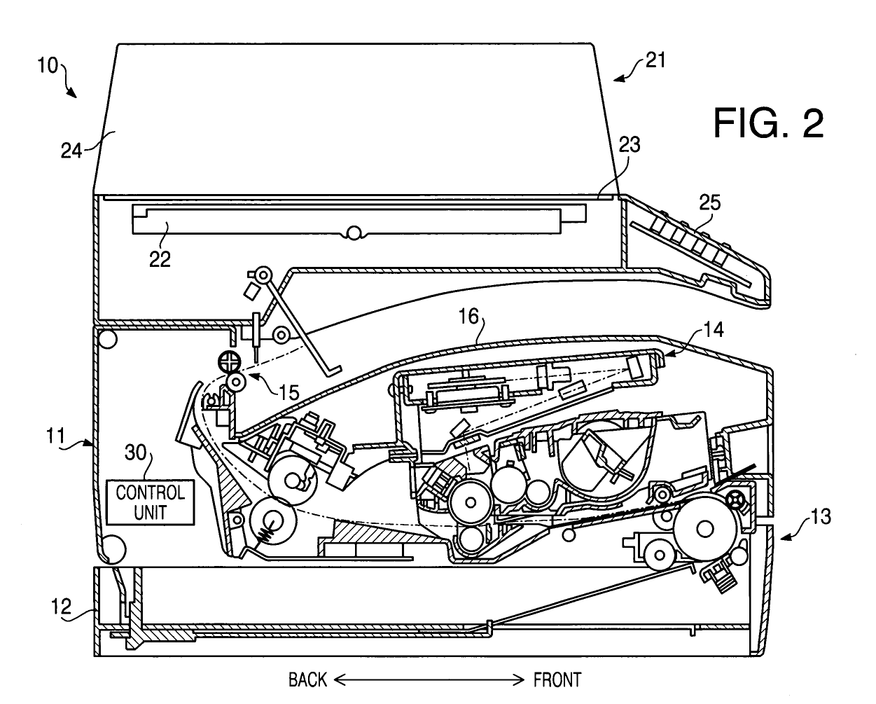

FIG. 2 illustrates an inner structure of the MFP 10. As shown in FIG. 2, the MFP 10 has an image formation unit 11 which forms an image on a recording sheet, and an image reading unit 21 which reads an image from an original. The image formation unit 11 and the image reading unit 21 are arranged such that the image formation unit 11 is stacked on the image reading unit 12.

In the lower part of the image formation unit 11, a sheet supply cassette 12 which accommodates a stack of recording sheets is located. The sheet supply cassette 12 can be detachable attached to the lower part of the mage formation unit 11 from the front side. In the image formation unit 11, a sheet supply unit 13 supplies sheets to an image forming portion 14 one-by-one, and an image is formed on the sheet at the position of the image forming portion 14. An output tray 16 is formed on the top surface of the image formation unit 11 so that the sheet on which an image is formed is ejected to the output tray 16 through an ejection unit 15.

The image reading unit 21 is rotatably attached to the image formation unit 11 to enable a user to easily pick up the sheet ejected on the output tray 16. In the image reading unit 21, a reading sensor 22 is provided to be movable along a platen glass 23 so that an image can be read from an original placed on the platen glass 23. The image reading unit 21 includes an ADF (Automatic Document Feeder) 24 so that an original can be automatically carried to the platen glass 23 and an image can be read from the original carried to the platen glass 23. On the front side of the image formation unit 1, the operation unit 25 is provided. The user is allowed to operate the MFP 10 through the operation unit 25.

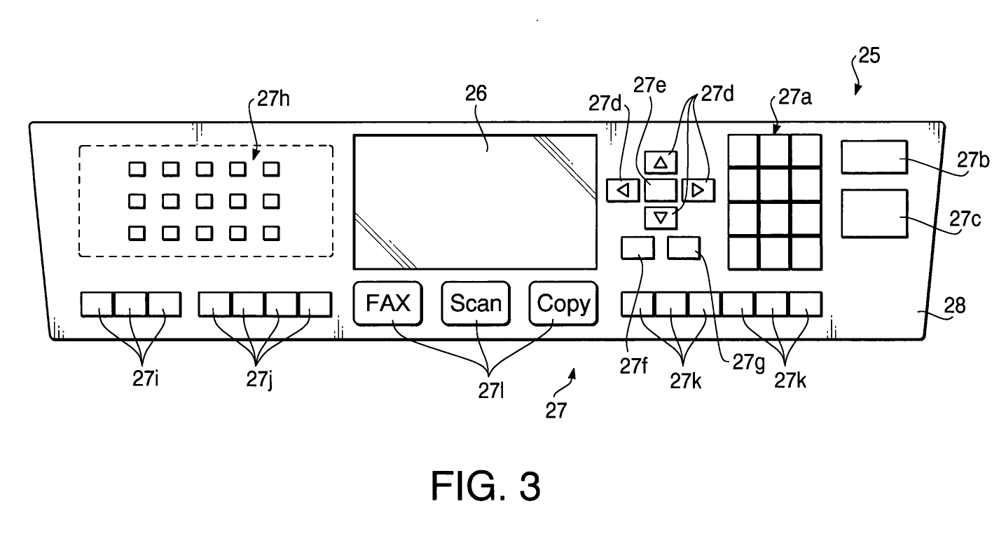

FIG. 3 is a plan view of the operation unit 25. As shown in FIG. 3, the operation unit 25 is formed such that a plurality of keys 27 are exposed through a cover plate 28. An LCD (Liquid Crystal Display) 26 is placed in a central portion of the operation unit 25, and various keys are placed around the LCD 26.

The keys 27 include a ten-key 27a and function keys used to input instructions to the MFP 10. For example, the function keys include a Stop/Exit key 27b for suspending or canceling an operation of the MFP 10, a Start key 27c for instructing the MFP 10 to start an operation, arrow keys 27d used to switch onscreen representations of the LCD 26 or to select instructions, an OK key 27e for confirming an operation, a clear key 27f for displaying a menu of the functions of the MFP 10 on the LCD 26, abbreviated dialing keys 27h for managing registered telephone numbers as abbreviated numbers, Print-specific keys 27i dedicated to the print function, FAX-specific keys 27j dedicated to the facsimile function, Copy-specific keys 27k dedicated to the copying function, and mode switch keys 27l used to switch operations between the facsimile function, the copying function and the scanner function.

The MFP 10 includes a control unit 30 which controls internal units including the sheet supply unit 13, the image formation unit 14, the ejection unit 15, the reading sensor 22, the LCD 26 and the keys 27 to execute the functions.

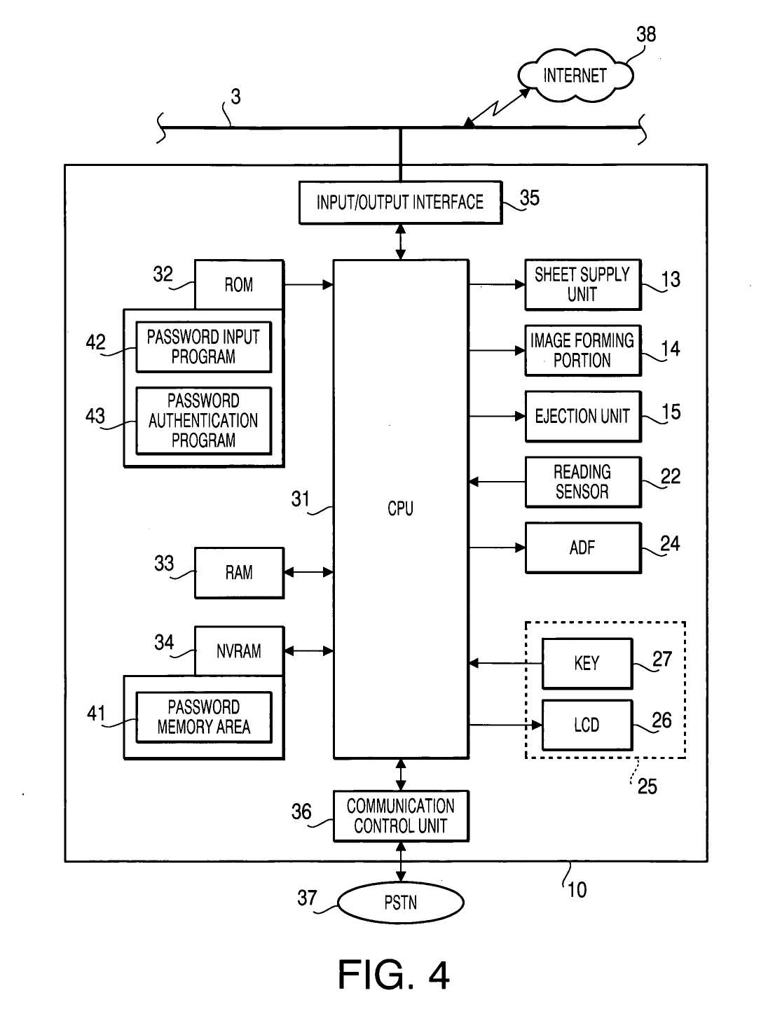

FIG. 4 illustrates a block diagram of the control unit 30. The control unit 30 has a general configuration as a computer. As shown in FIG. 4, the control unit 30 includes a CPU 31, a ROM 32, a RAM 33, an NVRAM 34. In the ROM 33, a password input program 42 which, when executed by the CPU 31, controls input of passwords, a password authentication program 43 which, when executed by the CPU 31, executes user authentication and executes a particular function. In the NVRAM 34, a password memory area 41 for storing an inputted password is provided.

The CPU 31 is connected to the LAN 3 via an input/output interface 35, and is able to communicate with the PC 2 via the input/output interface 35. The sheet supply unit 13, the image formation unit 14, the ejection unit 15, the reading sensor 22 and the ADF 24 are connected to the input/output interface 35 via the CPU 31. In this configuration, the CPU 31 controls a printing operation where data read by the reading sensor 22 or image data transmitted from the PC 2 is printed on a recording sheet. Further, the CPU 31 is able to connect to a public switched telephone network (PSTN) 37 or the Internet (not shown) via a communication control unit 36 to execute transmission of data (e.g., facsimile data or image data) to and receive data from an external device located outside the password setting system 1.

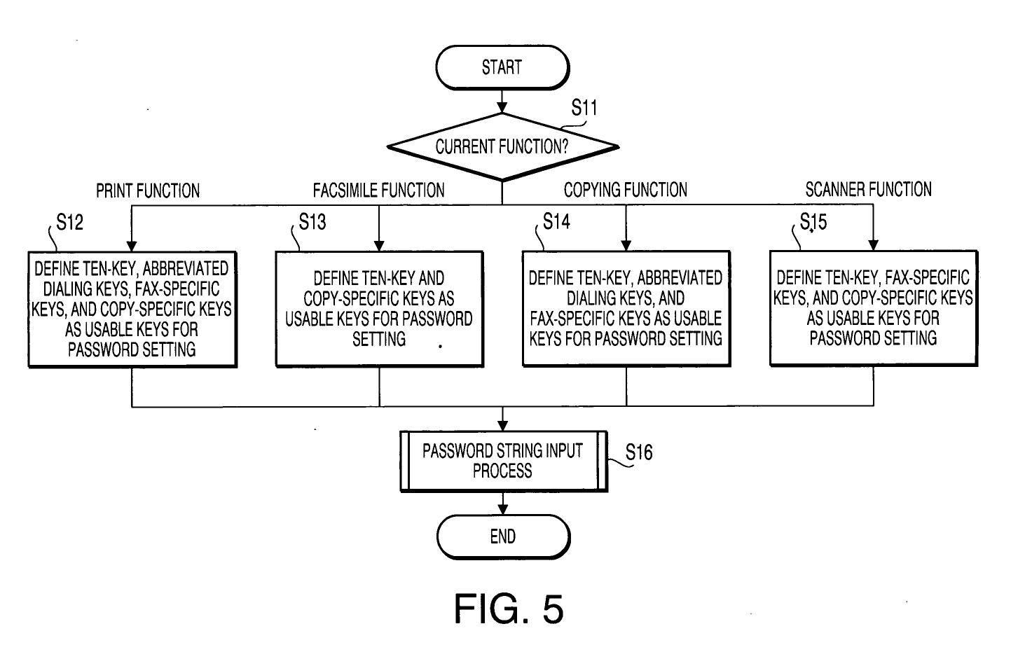

Hereafter, the password input program 42 is explained. FIG. 5 is a flowchart illustrating the password input program. The password input program 42 is loaded from the ROM 32 when the user operates the keys 27 of the operation unit 25, and is executed by the CPU 31. When executed by the CPU 31, the password input program 42 selects keys to be used for operation of password setting from among the keys 27 on the operation unit 25 depending on the operation mode currently set (i.e., a current function). That is, usable keys for password setting are changed depending on the type of the currently set function. Further, by the password input program 42, a password inputted by the user through the usable keys is stored in the password memory area 41.

As shown in FIG. 5, in step S11, the CPU 31 checks the type of the current function which is currently selected by the user, for example, by detecting operations conducted for the Print-specific keys 27i, the FAX-specific keys 27j, the Copy-specific keys 27k or the mode switch keys 27l.

If the CPU 31 detects that the Print-specific keys 27i are operated, the CPU 31 judges that the current function is the print function (S11: Print Function), and control proceeds to step S12 where the CPU 31 defines the ten-key 27a, the abbreviated dialing keys 27h, the FAX-specific keys 27j, and the Copy-specific keys 27k as usable keys for password setting. Then, control proceeds to step S16.

If the CPU 31 detects that the FAX-specific keys 27j or a FAX key in the mode switch keys 27l are operated, the CPU 31 judges that the current function is the facsimile function (S11: Facsimile Function), and control proceeds to step S13 where the CPU 31 defines the ten-key 27a, and the Copy-specific keys 27k as usable keys for password setting. Then, control proceeds to step S16.

If the CPU 31 detects that the Copy-specific keys 27k or a Copy key in the mode switch keys 27l are operated, the CPU 31 judges that the current function is the copying function (S11: Copying Function), and control proceeds to step S14 where the CPU 31 defines the ten-key 27a, the abbreviated dialing keys 27h, and the FAX-specific keys 27j as usable keys for password setting. Then, control proceeds to step S16.

If the CPU 31 detects that a SCAN key in the mode switch keys 27l is operated, the CPU 31 judges that the current function is the scanner function (S11: Scanner Function), and control proceeds to step S13 where the CPU 31 defines the ten-key 27a, the FAX-specific keys 27j and the Copy-specific keys 27k as usable keys for password setting. Then, control proceeds to step S16.

By thus processing the steps S11-S15, the usable keys which can be used for password setting can be changed depending on the type of the current function.

After the usable keys are thus defined depending on the type of the current function, the CPU 31 executes a password string input process (step S16) where a password (i.e., a character string) is accepted.

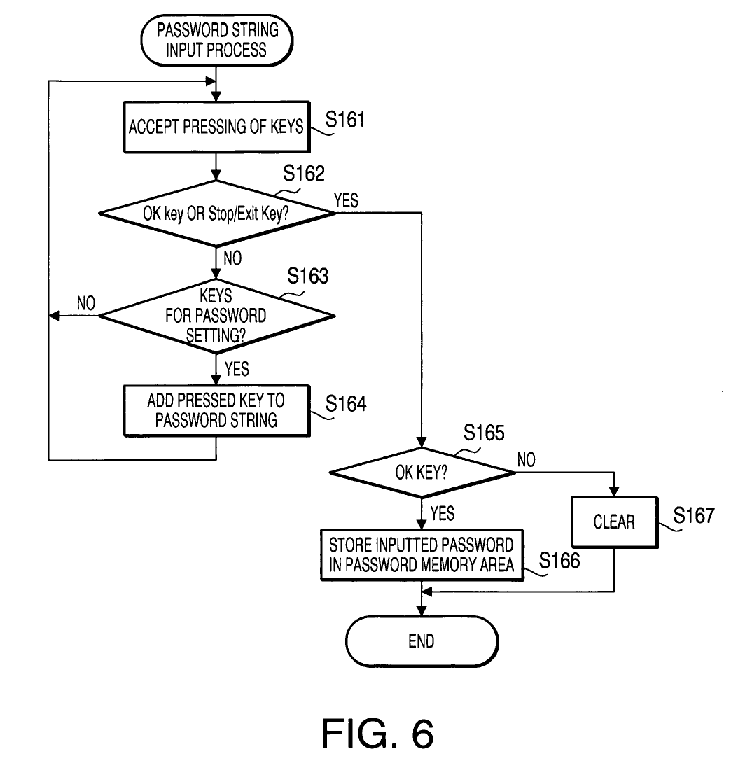

FIG. 6 is a sub-flowchart illustrating the password string input process. The password input process is executed each time one of the keys 27 provided on the operation unit 25 is pressed. In step S161, the CPU 31 accepts pressing of one of the keys 27 provided on the operation unit 25. Then, the CPU 31 judges whether the OK key 27e is pressed to indicate completion of input of a password or the Stop/Exit key 27b is pressed to stop input of a password. If none of the OK key 27e and the Stop/Exit key 27b is pressed (S162: NO), control proceeds to step S163 where the CPU 31 judges whether the pressed key belongs to the usable keys (i.e., keys for password setting) defined in one of steps S12-S15.

If the pressed key does not belong to the usable keys for password setting (S163: NO), the pressed key is neglected and control returns to step S161 to wait for key operation. If the pressed key belongs to the usable keys for password setting (S163: YES), data of the pressed key is added to a password string. In this case, the inputted key is displayed as an asterisk (*) so as to prevent the inputted password from being stolen by another person. Then, control returns to step S161.

Thus, the user is allowed to input a desired password while the CPU 31 repeatedly executes steps S161-S164. If the OK key 27e is pressed (S162: YES, S165: YES), the CPU 31 recognizes that input of a password is completed and the CPU 31 stores the inputted password in the password memory area 41 (step S166). Then, the password input process terminates, and control returns to the process shown in FIG. 5. Then, the process of the password input program shown in FIG. 5 terminates.

If the Stop/Exit key 27b is pressed (S162: YES, S165: NO), control proceeds to step S167 where the inputted password (i.e., the keys which have been inputted before now) is cleared. Then, control returns to the process shown in FIG. 5. Then, the process of the password input program shown in FIG. 5 terminates.

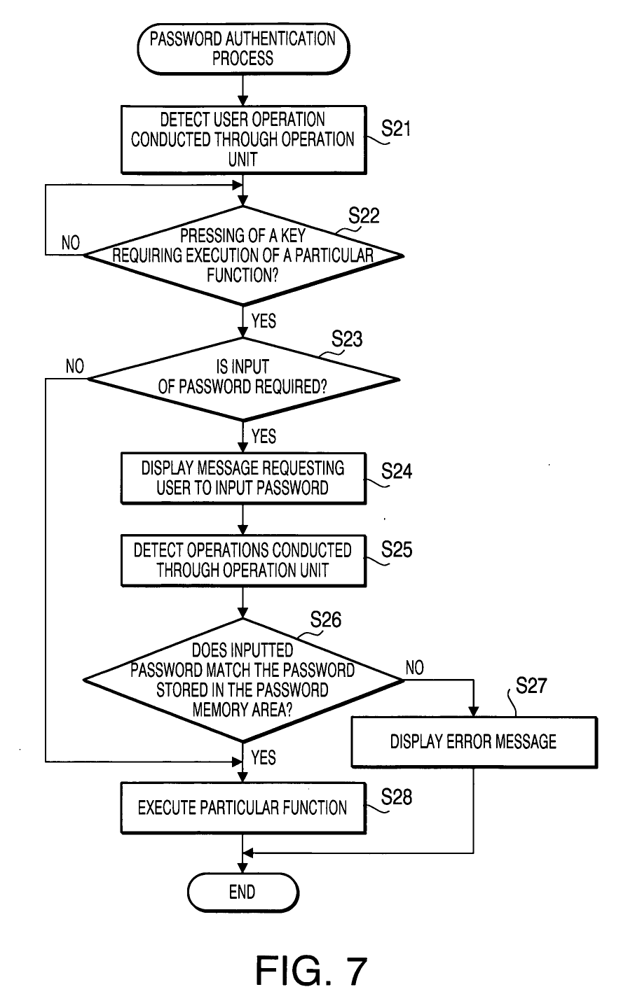

Hereafter, the password authentication program is explained. FIG. 7 is a flowchart illustrating a password authentication process corresponding to the password authentication program. The password authentication program is loaded by the CPU 31 from the ROM 32 when a command for executing the function for which the password is inputted is inputted to the MFP 10 through the operation unit 25, and is executed under control of the CPU 31.

First, the CPU 31 detects user operation conducted through the operation unit 25 (step S21). Then, the CPU 31 judges whether the detected user operation corresponds to pressing of a key requiring execution of a particular function (step S22). If the CPU 31 judges that the detected user operation corresponds to a key not requiring execution of a particular function (e.g., the ten-key 27a) (S22: NO), the CPU 31 repeats step S22.

If the CPU 31 judges that the detected user operation corresponds to pressing of a key requiring execution of a particular function (S22: YES), the CPU 31 judges whether the particular function requires input of a password (step S23). For example, if the user operates the operation unit 25 to check the remaining amount of toner, input of a password is not required (S23: NO). Therefore, in this case, control proceeds to step S28. On the other hand, if the detected user operation corresponds to a command for execution of the function requiring input of a password (e.g., the print function or scanner function) (S23: YES), the CPU 31 displays a message requesting the user to input a password on the LCD 26 (step S24). For example, in step S24, a message “Please input a password” is displayed.

Next, in step S25, the CPU 31 detects operations conducted through the operation unit 25. In this case, asterisks “** . . . ” are displayed in response to entry of keys of the password so as to prevent the inputted password from being stolen by another person.

Then, the CPU 31 judges whether the inputted password (which is inputted in step S25) matches the password stored in the password memory area 41 (step S26). That is, the CPU 31 judges whether the password inputted through the operation unit 25 to execute the particular function matches the password inputted in the process shown in FIG. 5.

If the password inputted through the operation unit 25 does not match the password stored in the password memory area 41 (S26: NO), the CPU 31 displays an error message (e.g., a message “A requested command can not be executed because the passwords do not match.”) on the LCD 26. In this case, the password authentication process terminates without executing the requested function.

If the password inputted through the operation unit 25 matches the password stored in the password memory area 41 (S26: YES), the particular function is executed (step S28).

Hereafter, operation modes of the MFP 1 and the password setting system 1 are explained. First, a secured printing operation is described. The secured printing operation means an operation where print data transmitted from the PC 2 to the MFP 10 is temporarily stored in the MFP 10 without immediately printing the received print data and thereafter the MFP 10 prints the stored print data when a sender of the print data operates the MFP 10 and inputs a print command.

For example, to print confidential data, the user selects a secured printing operation by operating the operation unit 25 before printing the confidential data. Since the secured printing operation belongs to the print function, the ten-key 27a, the abbreviated dialing keys 27h, the FAX-specific keys 27j and the Copy-specific keys 27k become usable during password setting.

The user inputs a password string by operating some or all of the ten-key 27a, the abbreviated dialing keys 27h, the FAX-specific keys 27j and the Copy-specific keys 27k, and presses the OK key 27e to store the inputted password string to the password memory area 41. For example, the user may press a key “1” of the ten-key 27a, a key “2” of the abbreviated dialing keys 27h, a key “3” of the ten-key 27a, a key “on-hook” of the FAX-specific keys 27j, and a key “5” of the abbreviated dialing keys 27h. The user may input a password string by using the usable keys (the ten-key 27a, the abbreviated dialing key 27h, the FAX-specific keys 27j and the Copy-specific keys 27k) in combination. The user is also able to input a password string by simultaneously pressing a plurality of keys of the usable keys.

Thereafter, the user moves to the place of the PC 2 and transmits confidential data from the PC 2 to the MFP 10 along with a command for a secured printing operation.

In response to receipt of the confidential data, the MFP 10 analyses the command for a secured printing operation, and temporarily stores the confidential data in the RAM 33. If the user moves to the place of the MFP 10 and selects the secured printing operation by operating the Print-specific keys 27i, the MFP 10 judges that input of a password is necessary, and displays a password input screen on the LCD 26 (see S21, S22: YES, S23: YES, and S24 of FIG. 7). When the user presses the OK key 27e after inputting a password string through the operation unit 25, the MFP 10 judges whether the inputted password matches the password stored in the password memory area 41 (see S25, S26 of FIG. 7).

For example, if the user presses a key “1” of the ten-key 27a, a key “2” of the abbreviated dialing keys 27h, a key “3” of the ten-key 27a, a key “on-hook” of the FAX-specific keys 27j and a key “5” of the abbreviated dialing keys 27h in this order, and then presses the OK key 27e, the inputted password string matches the password stored in the password memory area 41. In this case, the confidential data is read from the RAM 33 and is printed (see S26: YES, S28 of FIG. 7).

On the other hand, if the user presses a key “1” of the abbreviated dialing keys 27h, a key “2” of the abbreviated dialing keys 27h, a key “3” of the ten-key 27a, a key “on-hook” of the FAX-specific keys 27j and a key “5” of the abbreviated dialing keys 27h in this order, and then presses the OK key 27e, the inputted password string does not match the password stored in the password memory area 41 because the key “1” of the abbreviated dialing keys 27h in the inputted password string is different from the key “1” of the ten-key 27a of the stored password. In this case, the confidential data stored in the password memory area 41 is not printed, and an error message is displayed on the LCD 26 (see S26: NO, S27).

Hereafter, an example of an operation in which a confidential drawing is scanned by the MFP 10 and the scanned data is transmitted to the PC 2 is explained.

In the MFP 10, authorized users who are permitted to use the scanner function of the MFP 10 are registered. Each authorized user registers a password and an address of the user's own PC 2 in the MFP 10. In this case, the user presses a Scan key of the mode switch keys 27l on the operation unit 25 to select a security function (see S11 of FIG. 5).

Regarding the scanner function, the ten-key 27a, the FAX-specific keys 27j, the Copy-specific keys 27k become usable for the password setting (see S11: the scanner function, and S15 of FIG. 5). The user inputs a password string (e.g., a key “fax transmission” of the FAX-specific keys 27j, a key “scaling” of the Copy-specific keys 27k, and a key “1” of the ten-key 27a) and then presses the OK key 27e. In this case, the inputted password string is stored in the password memory area 41 (see S16 of FIG. 5 and FIG. 6). Further, when the user registers the address of the PC 2 in the MFP 10, the MFP 10 stores the address in the NVRAM 34 in association with the inputted password string.

To scan the confidential drawings, the user presses the Scan key of the mode switch keys 27l to specify the function to be executed (see S21, S22: YES f FIG. 7). In this case, since only the authorized users are permitted to use the scanner function and each of the authorized uses has inputted the password, the MFP 10 displays the password input screen on the LCD 26 (see S23: YES, S24 of FIG. 7).

If the user inputs a password string (e.g., a key “fax transmission” of the FAX-specific keys 27j, a key “scaling” of the Copy-specific keys 27k, and a key “1” of the ten-key 27a) and presses the OK key 27e, the MFP 10 judges that the inputted password string matches the password stored in the password memory area 41 (S25, S26: YES of FIG. 7). Then, the MFP 10 displays a message “Scan is permitted.” on the LCD 26 and moves to a state where the user operation regarding the scanner function is accepted. Therefore, the user places the confidential drawing on the image reading unit 21 and presses the Start key 27c to scan the confidential drawing. Then, the scanned data is transmitted to the address of the PC 2 stored in association with the inputted password string.

After the scanning operation is finished and the user returns to the place of the PC 2, the user is able to open the file of the confidential drawing and to view the scanned confidential drawing on the PC 2.

It is understood that the above mentioned configuration makes it possible to avoid another PC 2 of another user from accidentally receiving the confidential drawing and thereby being interrupted by receipt of the confidential drawing and to avoid the confidential drawing from being transmitted to another device of an outside person.

Settings of the MFP 10 are modified, for example, to add an authorized user of the scanner function to the MFP 10. In such a case where the settings of the MFP 10 are modified, it is possible to prevent the settings of the MFP 10 from being modified by an unauthorized user by requesting a user who intends to modify the settings of the MFP 10 to input a password.

Hereafter, advantages of the first embodiment are described. As described above, the MFP 10 changes the usable keys for the password setting of the keys 27 depending on the type of the function of the MFP 10 (see S11-S15 of FIG. 5). To set the password, the user inputs the password string by using the usable keys defined depending on the type of the current function of the MFP 10 (S16 of FIG. 5, S163: YES, S164 of FIG. 6). To select a particular function (e.g., a secured printing operation) trough the operation unit 25 and to execute the selected function, the MFP 10 compares the password string inputted through the operation unit 35 with the password stored in advance in the password memory area 41. Only if these passwords match each other, the MFP 10 executes the particular function (S26: YES, S27 of FIG. 7).

Since usable keys which can be used in password setting are limited depending on the type of the function and therefore the types of keys to be used for password setting become complicated, security against unauthorized access is enhanced in comparison with the case where the user is allowed to use all of the keys 27 with respect to all of the functions of the MFP 10.

Regarding the password setting for a particular function (e.g., a scan-to-mail function), the MFP 10 defines keys which are not used for the scanner function (i.e., the ten-key 27a, the FAX-specific keys 27j and the Copy-specific keys 27k) as the usable keys for the password setting. Such a configuration makes it possible to prevent the user from mistakenly inputting a command for execution of the scanner function during the password setting and thereby to prevent the scanned data from erroneously being transmitted to the PC 2 of another user.

The MFP 10 defines the abbreviated dialing keys 27h as the usable keys for the password setting, and the abbreviated dialing keys 27h are managed as a train of numbers. Therefore, by using the abbreviated dialing keys 27h with the ten-key 27a, it is possible to achieve the level of security more than twice as much as the level of security of the case where only ten-key 27a is used for the password setting.

### Second Embodiment

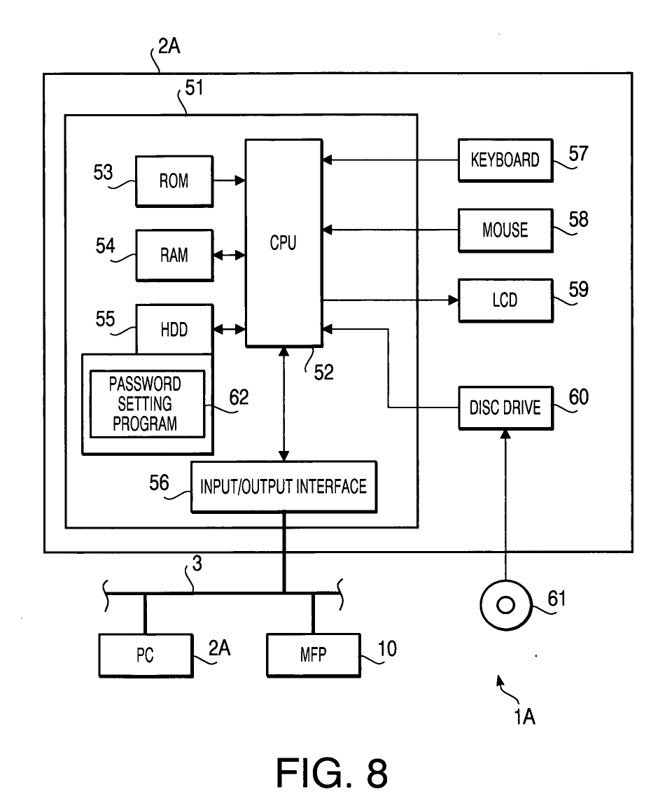

FIG. 8 illustrates a system configuration of a password setting system 1A according to a second embodiment. Similarly to the first embodiment, in the password setting system 1A a plurality of PCs (2A, 2A, . . . ) are connected to the MFP 10. In FIG. 8, to elements which are substantially the same as those of the first embodiment, the same reference numbers are assigned, and explanations thereof will not be repeated. The feature of the second embodiment is that the PC 2A accepts password entry. Therefore, the following explanations focus on the features of the second embodiment.

In the password setting system 1A, the MFP 10 and the PCs 2A can communicate with each other via the LAN 3. The PC 2A has a general configuration as a computer, and includes a control unit 51, an input unit (e.g., a keyboard 57 and a mouse 58), an LCD 59, and a disc drive 60 through which information is read from a recording medium 61 (e.g., a CD).

The control unit 51 includes a CPU 52, a ROM 53, a RAM 54, an HDD (hard disk drive) 55, and an input/output interface 56. In the HDD 55, a password setting program 62 is stored. For example, the password setting program 62 is read from the recording medium 61 via the disc drive 60, and is stored in the HDD 55.

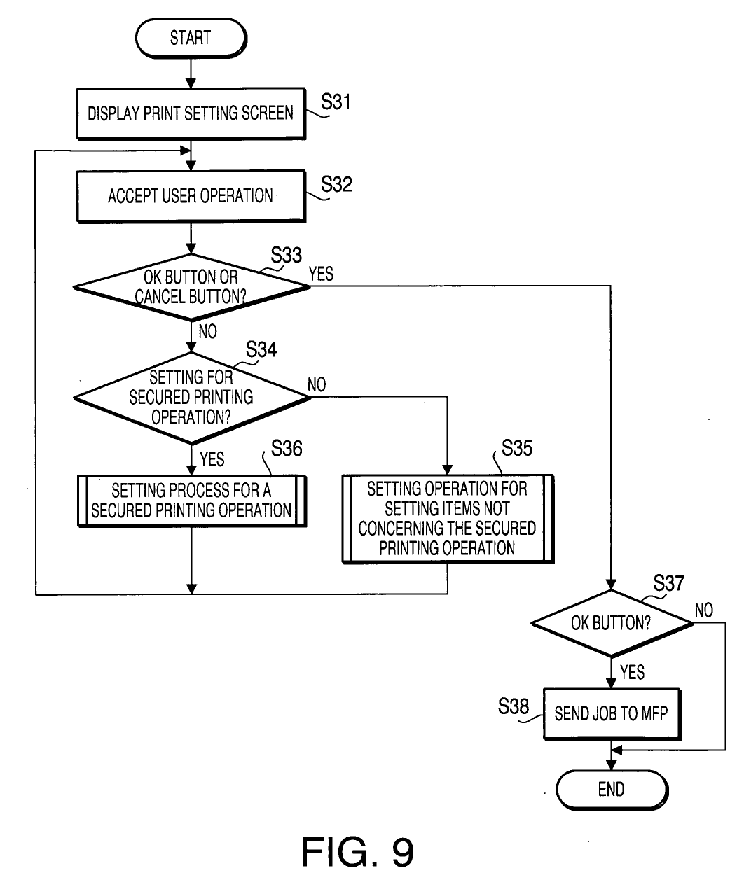

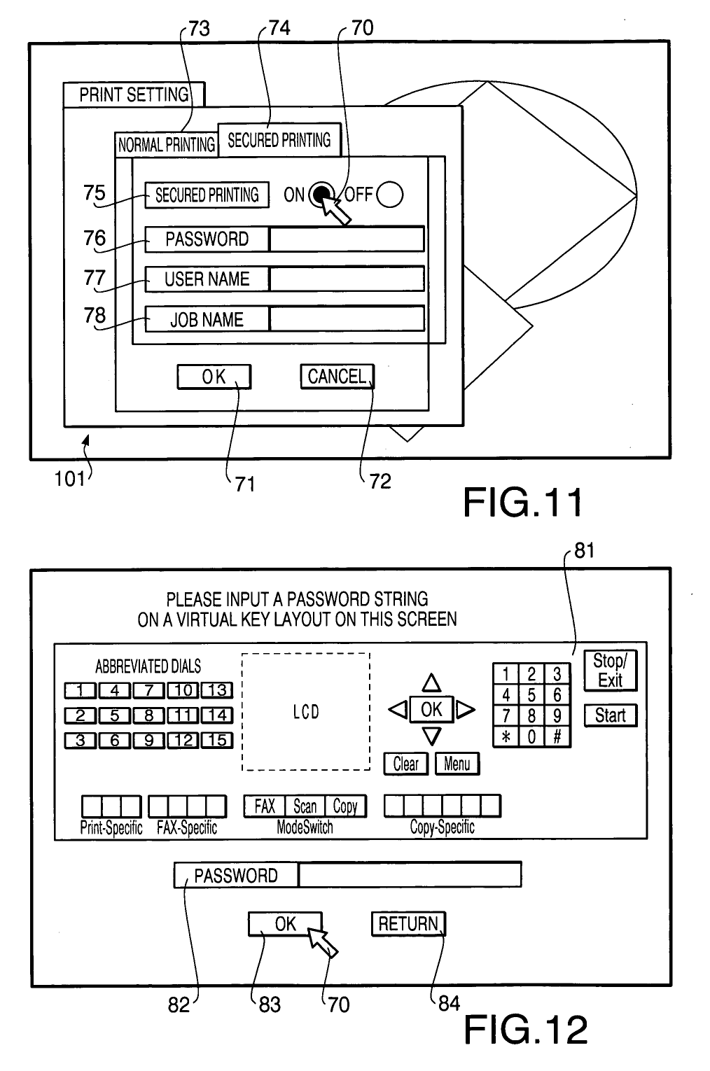

FIG. 9 is a flowchart illustrating a password setting process corresponding to the password setting program 62. When the PC 2A is turned on, the password setting program 62 is loaded from the HDD 55 and is executed under control of the CPU 52. FIG. 11 illustrates an example of a print setting screen displayed during execution of the password setting process shown in FIG. 9. As described below, the password setting program 62 controls password setting.

As shown in FIG. 9, in step S31, the CPU 52 displays a print setting screen 101 shown in FIG. 11 on the LCD 59. The print setting screen 101 includes a setting column 74 for a secured printing operation as well as a setting column 73 for a normal printing operation. Through the setting column 73 for a normal printing operation, various types of settings, such as a paper size and margins, can be inputted. The print setting screen 101 also includes an OK button 71 and a CANCEL button 72.

In step S32, a user operation is accepted. That is, the user is allowed to input desired print settings into the print setting screen 101 by operating the keyboard 57 and the mouse 58. Next, in step S33, the CPU 52 judges whether the OK button 71 or the CANCEL button 72 is pressed. If none of the OK button 71 and the CANCEL button 72 is pressed (S33: NO), control proceeds to step S34 where the CPU 52 judges whether the user operates the print setting screen to open the setting column 73 for a secured printing operation. If the user does not operate the print setting screen 101 to open the setting column 73 (S34: NO), the CPU 52 executes a setting operation for setting items not concerning the secured printing operation (step S35). If the user operates the print setting screen 101 to open the setting column 73 (S34: YES), the CPU 52 executes a setting process for a secured printing operation (step S36).

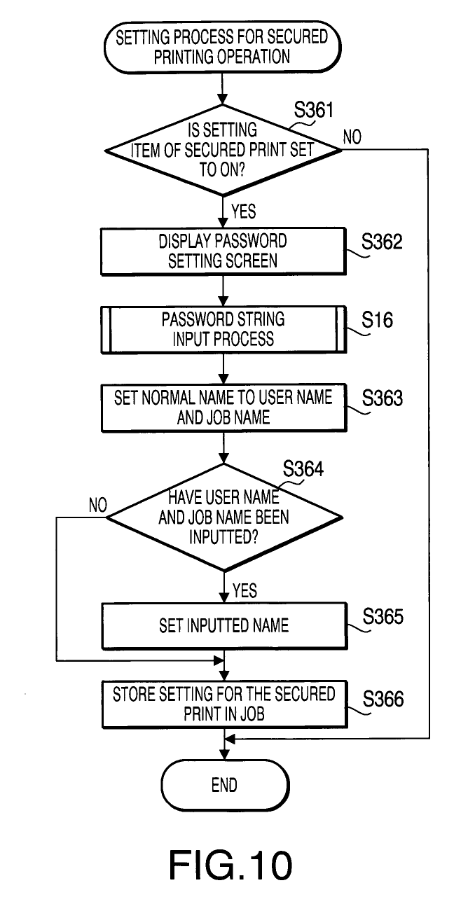

FIG. 10 is a flowchart illustrating the setting process for a secured printing operation. FIG. 12 is an example of a password setting screen displayed during the setting process for a secured printing operation.

As shown in FIG. 10, first, the CPU 52 judges whether a setting item of secured print is set to ON (step S361). More specifically, the CPU 52 judges whether a radio button “ON” has been clicked on a secured print setting field 75. If a radio button “OFF” has been clicked on the secured print setting field 75 (S361: NO), the setting process for a secured printing operation terminates. Then, control returns to step S32 of FIG. 9.

If the radio button “ON” has been clicked on the secured print setting field 75 (S361: YES), the CPU 52 displays the password setting screen shown in FIG. 12 on the LCD 59 (S362). As shown in FIG. 12, the password setting screen includes a virtual key operation unit 81 which is a virtual image of the operation unit 25 of the MFP 10, a password display field 82 in which a password string inputted by operating the virtual key operation unit 81 is displayed, an OK button 83 used to instruct the PC 2A that entry of the password string is completed, and a RETURN button 84 used to stop the password setting.

In step S16, the CPU 52 executes the password string input process where the user inputs a password string as indicated in step S16 of FIG. 5 and in FIG. 6. In this embodiment, a password string is inputted by locating a cursor 70 to a position of a desired key on the virtual key operation unit 81. In this case, virtual keys corresponding to the usable keys in the print function (i.e., the ten-key 27a, the abbreviated dialing keys 27h, the FAX-specific keys 27j, and the Copy-specific keys 27k) are displayed in red color so as to be easily distinguishable from other keys.

Since the inputted password string is displayed in the password display field 82, the user is able to recognize the password string that the user inputted. After completing entry of the password string, the user clicks the OK button 83. If the user wants to stop the password setting, the user clicks the RETURN button 84.

Next, in step S363, the CPU 52 sets a normal user name in a user name input field 77 and sets a normal job name (e.g., a first character string of a name of print data) into a job name input field 78 so that the user name and the job name identify print data targeted for the secured print from another print data. Then, the CPU 52 judges whether the user has inputted a user name and a job name in the user name input field 77 and the job name input field 78, respectively. If the user name and the job name have been inputted by the user (S364: YES), the CPU 52 changes a user name of a job from the normal user name set at step S363 to the user name inputted by the user and changes a job name for a job from the normal job name set at step S363 to the job name inputted by the user (step S365). Then, control proceeds to step S366.

If the CPU 52 judges that the user name and the job name have not been inputted by the user (S364: NO), control proceeds to S366 while retaining the normal user name and the normal job name. In step S366, the settings for the secured print are stored in a job. Then, control returns to step S32 of FIG. 9.

Referring back to FIG. 9, if the user has finished the print setting as described above and presses the OK button 71 or the CANCEL button 72 through the keyboard 57 or the mouse 58 (S33: YES), control proceeds to step S37 where the CPU 52 judges whether the clicked button is the OK button 71. If the clicked button is the OK button 71 (S37: YES), the CPU 52 transmits the job to the MFP 10 via the input/output interface 56 and the LAN 3.

If the CPU 52 judges that the clicked button is the CANCEL button 72 (S37: NO), the CPU 52 terminates the password setting process without transmitting the job to the MFP 10 because in this case the user does not intend to execute the printing operation.

When receiving the job containing a command for the secured print from the PC 2A, the MFP 10 temporarily stores the print data in the NVRAM 34. In this case, the print data is stored in the NVRAM 34 in association with the user name, the job name, and the password set by the PC 2A so that the print data can be distinguished from another print data.

In this embodiment, the same password authentication process as that shown in FIG. 7 is executed to print the print data. That is, the user inputs a secured print command by specifying the user name and the file name through the operation unit 25 of the MFP 10. Then, a password input screen is displayed on the LCD 26 so as to allow the user to input a password. Then, the MFP 10 checks whether the inputted password matches the password associated with the print data specified by the user name and the job name. If these passwords match each other, an image corresponding to the specified print data is printed on a recording sheet. If these passwords do not match, the specified print data is not printed. In this case, an error message may be displayed on the LCD 26.

Hereafter, advantages of the second embodiment are described. In the password setting system according to the second embodiment, the virtual operation unit 81 which is an virtual image of the operation unit 25 of the MFP 10 is displayed on the LCD 59 of the PC 2A, and the user inputs a password on the screen of the LCD 59 of the PC 2A (see S363 of FIG. 10, S16, and FIG. 12). Then, the inputted password is transmitted from the PC 2A to the MFP 10 via the LAN 3 (see S38 of FIG. 9). The MFP 10 receives the password from the PC 2A via the LAN 3. When a password is inputted to the MFP 10 to execute a particular function, the MFP 10 compares the inputted password with the password received form the PC 2A. Then, if the inputted password and the password received form the PC 2A mach each other, the MFP 10 permits execution of a print operation for printing the print data contained in the job for the secured print (see FIG. 7).

As described above, in the password setting system 1A, the password entry is conducted on the PC 2A which can be located at a hidden position. Therefore, according to the password setting system 1A of the second embodiment, it is possible to prevent passwords from being stolen by another person. Consequently, the security level can be increased.

A password is inputted using the virtual operation unit 81 corresponding to a virtual image of the operation unit 25 of the MFP 10. Such a configuration enables the user, who is operating the operation unit 25 of the MFP 10 to input a password, to easily recall the password which the user has set in advance.

As described above, on the virtual operation unit 81, the usable keys for the password setting are displayed in red color so that the usable keys for the password setting can be distinguished from other keys (see FIG. 12). Such a configuration enables the user to easily distinguish the usable keys form other keys and thereby to easily input a password on the PC 2A. Since types of keys (i.e., virtual keys on the virtual operation unit 81) which can be used for the password setting are limited depending on the current function, a password can be complicated and thereby it becomes possible to enhance the security level.

According to the password setting program 62 of the second embodiment, the virtual operation unit 81 corresponding to an image of the operation unit 25 is displayed on the LCD 59 of the PC 2A, and the password inputted through the virtual operation unit 81 is transmitted from the PC 2A to the MFP 10 (S36 of FIG. 9, FIG. 10, and S38 of FIG. 9). Such a configuration prevents another person from easily stealing the password during the password setting. Consequently, the security level can be enhanced.

According to the password setting program 62 of the second embodiment, the usable keys for the password setting are displayed in red color (see FIG. 12). Such a configuration enables the user to easily input a password. Since keys to be used for the password setting are limited depending on the current function, it is possible to complicate a password and to enhance the security level.

Although the present invention has been described in considerable detail with reference to certain preferred embodiments thereof, other embodiments are possible.

What is claimed is:

1. A multifunction peripheral having a plurality of functions, comprising:
an operation unit that has a plurality of keys to be operated;
a key definition unit configured to define usable keys for password setting depending on a type of a certain function selected from the plurality of functions, the usable keys being chosen from among the plurality of the keys of the operation unit;
a password setting unit configured to accept a password through the usable keys defined by the key definition unit and to set the password in the multifunction peripheral;
a password authentication unit configured such that when execution of the certain function is instructed, the password authentication unit accepts a password through the plurality of keys of the operation unit and judges whether the password accepted through the plurality of keys matches the password set by the password setting unit; and
a function control unit configured to permit execution of the certain function if it is judged by the password authentication unit that the password accepted through the plurality of keys matches the password set by the password setting unit.

2. The multifunction peripheral according to claim 1, wherein the key definition unit defines the usable keys such that the usable keys change depending on a currently designated function.

3. The multifunction peripheral according to claim 1, wherein the usable keys include a ten-key and a function key.

4. The multifunction peripheral according to claim 1, wherein the key definition unit defines the usable keys such that the usable keys are keys not used for the certain function.

5. The multifunction peripheral according to claim 1, wherein the plurality of functions include at least two of a print function, a copying function, a facsimile function and a scanner function.

6. The multifunction peripheral according to claim 1, wherein:
the plurality of functions include a print function and a facsimile function; and
the key definition unit defines the usable keys such that if the print function is set as the certain function, the usable keys include abbreviated dialing keys.

7. A password setting system, comprising:
an information processing device; and
a multifunction peripheral having a plurality of functions,
the information processing unit and the multifunction peripheral being communicatably connected with each other,
the information processing device comprising:
a display control unit configured to display a virtual key operation unit corresponding to an image of an operation unit of the multifunction peripheral;
a password setting unit configured to accept an password through the virtual key operation unit and to set the password in the information processing device; and
a password transmission unit configured to transmit the password set by the password setting unit to the multifunction peripheral,
the multifunction peripheral comprising:
the operation unit having a plurality of keys;
a password receiving unit configured to receive the password from the information processing device;
a password authentication unit configured such that when execution of a certain function is instructed, the password authentication unit accepts a password through the operation unit and judges whether the password accepted through the plurality of keys of the operation unit matches the password received by the password receiving unit; and
a function control unit configured to permit execution of the certain function if it is judged by the password authentication unit that the password accepted through the operation unit matches the password received by the password receiving unit.

8. The password setting system according to claim 7, wherein the display control unit of the information processing device displays the virtual key operation unit such that usable virtual keys for password setting selected from virtual keys of the virtual key operation unit are distinguishable from keys other than the usable keys.

9. The password setting system according to claim 8, wherein the virtual usable keys for password setting are defined depending on a type of a certain function selected from the plurality of functions of the multifunction peripheral.

10. A computer readable medium having computer readable instruction stored thereon, which, when executed by a processor of an information processing device communicatably connected to a multifunction peripheral, configures the processor to perform the steps of:
displaying a virtual key operation unit corresponding to an image of an operation unit of the multifunction peripheral;
accepting a password through the virtual key operation unit; and
transmitting the accepted password to the multifunction peripheral.

11. The computer readable medium according to claim 10,
wherein the step of displaying comprises displaying the virtual key operation unit such that usable virtual keys for password setting selected from virtual keys of the virtual key operation unit are distinguishable from keys other than the usable keys.

12. A method for controlling a multifunction peripheral for executing a certain function selected from a plurality of functions of the multifunction peripheral, comprising the steps of:
defining usable keys for password setting depending on a type of the certain function selected from the plurality of functions, the usable keys being chosen from among a plurality of keys of an operation unit of the multifunction peripheral;
accepting a password through the defined usable keys to set the password in the multifunction peripheral;
accepting a password through the plurality of keys of the operation unit to judge whether the password accepted through the plurality of keys matches the password set in the multifunction peripheral when execution of the certain function is instructed; and
permitting execution of the certain function if it is judged that the password accepted through the plurality of keys matches the password set in the multifunction peripheral.

13. The method according to claim 12, wherein in the step of defining the usable keys, the usable keys are defined such that the usable keys are keys not used for the certain function.

14. The method according to claim 12,
wherein the operation unit of the multifunction peripheral is a virtual key operation unit displayed on a screen as an image corresponding to the operation unit of the multifunction peripheral,
wherein the method further comprises the step of:
displaying the virtual key operation unit on the screen such that usable virtual keys for password setting selected from virtual keys of the virtual key operation unit are distinguishable from keys other than the usable keys.
